(19) United States
(12) Patent Application Publication
(10) Pub. No.: US 2025/0261128 A1
(43) Pub. Date: Aug. 14, 2025

(54) LOW SIGNAL-TO-NOISE RATIO (SNR) OPERATION WITH DUTY CYCLE SELECTION

(71) Applicant: QUALCOMM Incorporated, San Diego, CA (US)

(72) Inventors: Yavuz YAPICI, Florham Park, NJ (US); Juergen CEZANNE, Ocean Township, NJ (US); Junyi LI, Fairless Hills, PA (US)

(21) Appl. No.: 18/438,212

(22) Filed: Feb. 9, 2024

(51) Int. Cl. H04W 52/24; H04W 28/20; H04W 52/36

(52) U.S. Cl. CPC H04W 52/241; H04W 28/20; H04W 52/367

(57) ABSTRACT

Aspects of the present disclosure provide apparatus, methods, processing systems, and computer readable mediums for performing wireless communications in low signal-to-noise ratio (SNR) conditions with duty cycle selection. An example method by a network entity generally includes obtaining an indication of at least one signal strength parameter associated with the network entity at a user equipment (UE). The network entity signals the UE to perform a non-coherent transmission when a value of the at least one signal strength parameter is less than a threshold associated with a target bandwidth. The network entity monitors for the non-coherent transmission from the UE.

### BACKGROUND

### Field of the Disclosure

Aspects of the present disclosure relate to wireless communications, and more particularly, to techniques for performing wireless communications in low signal-to-noise ratio (SNR) conditions.

### Description of Related Art

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

These multiple access technologies have been adopted in various telecommunication standards to provide a common protocol that enables different wireless devices to communicate on a municipal, national, regional, and even global level. New radio (e.g., 5G NR) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. Preferably, these improvements should be applicable to other multi-access technologies and the telecommunication standards that employ these technologies.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages.

Certain aspects of the subject matter described in this disclosure can be implemented in a method for wireless communication by a network entity. The method generally includes obtaining an indication of at least one signal strength parameter associated with the network entity at a user equipment (UE). The method also includes signaling the UE to perform a non-coherent transmission when a value of the at least one signal strength parameter is less than a threshold associated with a target bandwidth. The method further includes monitoring for the non-coherent transmission from the UE.

Certain aspects of the subject matter described in this disclosure can be implemented in an apparatus for wireless communication. The apparatus generally includes one or more memories collectively storing computer-executable instructions, and one or more processors communicatively coupled to the one or more memories. The one or more processors are collectively configured to execute the computer-executable instructions to cause the apparatus to obtain an indication of at least one signal strength parameter associated with the apparatus at a user equipment (UE), signal the UE to perform a non-coherent transmission when a value of the at least one signal strength parameter is less than a threshold associated with a target bandwidth, and monitor for the non-coherent transmission from the UE.

Certain aspects of the subject matter described in this disclosure can be implemented in an apparatus for wireless communication. The apparatus generally includes means for obtaining an indication of at least one signal strength parameter associated with the apparatus at a user equipment (UE). The apparatus also includes means for signaling the UE to perform a non-coherent transmission when a value of the at least one signal strength parameter is less than a threshold associated with a target bandwidth. The apparatus further includes means for monitoring for the non-coherent transmission from the UE.

Certain aspects of the subject matter described in this disclosure can be implemented in a non-transitory computer readable medium having instructions stored thereon for obtaining, by a network entity, an indication of at least one signal strength parameter associated with the network entity at a user equipment (UE), signaling, by the network entity, the UE to perform a non-coherent transmission when a value of the at least one signal strength parameter is less than a threshold associated with a target bandwidth, and monitoring, by the network entity, for the non-coherent transmission from the UE.

Certain aspects of the subject matter described in this disclosure can be implemented in a method for wireless communication by a user-equipment (UE). The method generally includes determining at least one signal strength parameter associated with a network entity at the UE. A value of the at least one signal strength parameter is less than a threshold associated with a target bandwidth. The method also includes transmitting an indication of the at least one signal strength parameter to the network entity. The method also includes, after transmitting the indication of the at least one signal strength parameter, receiving a message from the network entity triggering the UE to perform a non-coherent transmission. The method further includes, after receiving the message, transmitting the non-coherent transmission to the network entity.

Certain aspects of the subject matter described in this disclosure can be implemented in an apparatus for wireless communication. The apparatus generally includes one or more memories collectively storing computer-executable instructions, and one or more processors communicatively coupled to the one or more memories. The one or more processors are collectively configured to execute the computer-executable instructions to cause the apparatus to determine at least one signal strength parameter associated with a network entity at the apparatus. A value of the at least one signal strength parameter is less than a threshold associated with a target bandwidth. The one or more processors are collectively configured to execute the computer-executable instructions to cause the apparatus to transmit an indication of the at least one signal strength parameter to the network entity, after transmitting the indication of the at least one signal strength parameter, receive a message from the network entity triggering the apparatus to perform a non-coherent transmission, and, after receiving the message, transmit the non-coherent transmission to the network entity.

Certain aspects of the subject matter described in this disclosure can be implemented in an apparatus for wireless communication. The apparatus generally includes means for determining at least one signal strength parameter associated with a network entity at the apparatus. A value of the at least one signal strength parameter is less than a threshold associated with a target bandwidth. The apparatus also includes means for transmitting an indication of the at least one signal strength parameter to the network entity. The apparatus also includes, after transmitting the indication of the at least one signal strength parameter, means for receiving a message from the network entity triggering the apparatus to perform a non-coherent transmission. The apparatus further includes, after receiving the message, means for transmitting the non-coherent transmission to the network entity.

Certain aspects of the subject matter described in this disclosure can be implemented in a non-transitory computer readable medium having instructions stored thereon for determining at least one signal strength parameter associated with a network entity at the apparatus, wherein a value of the at least one signal strength parameter is less than a threshold associated with a target bandwidth, transmitting an indication of the at least one signal strength parameter to the network entity, after transmitting the indication of the at least one signal strength parameter, receiving a message from the network entity triggering the apparatus to perform a non-coherent transmission, and after receiving the message, transmitting the non-coherent transmission to the network entity.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example telecommunications system, in accordance with certain aspects of the present disclosure.

FIG. 2 is a block diagram conceptually illustrating a design of an example a base station (BS) and user equipment (UE), in accordance with certain aspects of the present disclosure.

FIG. 3 is an example frame format for certain wireless communication systems (e.g., new radio (NR)), in accordance with certain aspects of the present disclosure.

FIG. 4 illustrates an example peaky-based non-coherent transmission, in accordance with certain aspects of the present disclosure.

FIG. 5 depicts an example call flow diagram for low SNR operation with duty cycle selection, in accordance with certain aspects of the present disclosure.

FIG. 6 illustrates another example peaky-based non-coherent transmission, in accordance with certain aspects of the present disclosure.

FIGS. 7A, 7B, and 7C are graphs illustrating examples of transmit scenario selection, according to certain aspects of the present disclosure.

FIGS. 8A and 8B are graphs illustrating examples of duty cycle selection, according to certain aspects of the present disclosure.

FIG. 9 illustrates example operations for wireless communication by a network entity, according to certain aspects of the present disclosure.

FIG. 10 illustrates example operations for wireless communication by a UE, according to certain aspects of the present disclosure.

FIG. 11 illustrates a communications device that may include various components configured to perform operations for the techniques disclosed herein in accordance with aspects of the present disclosure.

FIG. 12 illustrates a communications device that may include various components configured to perform operations for the techniques disclosed herein in accordance with aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums that may help improve wireless communication performance, for example, by allowing a switch between coherent and non-coherent transmissions. Advantageously, the techniques provided herein may allow for adaptation, for example, to low signal-to-noise ratio (SNR) channel conditions where non-coherent transmissions without pilot transmission (e.g., demodulation reference signals (DMRS)) may lead to better performance than coherent transmissions with pilot transmission.

The following description provides examples of techniques for performing wireless communications in low SNR conditions with duty cycle selection, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs. In some cases, a 5G NR RAT network may be deployed.

The techniques described herein may be used for various wireless networks and radio technologies. While aspects may be described herein using terminology commonly associated with 3G, 4G, and/or new radio (e.g., 5G NR) wireless technologies, aspects of the present disclosure can be applied in other generation-based communication systems.

NR access may support various wireless communication services, such as enhanced mobile broadband (eMBB) targeting wide bandwidth, millimeter wave mmW, massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QOS) requirements. In addition, these services may co-exist in the same subframe.

The electromagnetic spectrum is often subdivided, based on frequency/wavelength, into various classes, bands, channels, etc. In 5G NR two initial operating bands have been identified as frequency range designations FR1 (410 megahertz (MHz)-7.125 gigahertz (GHz)) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

NR supports beamforming and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

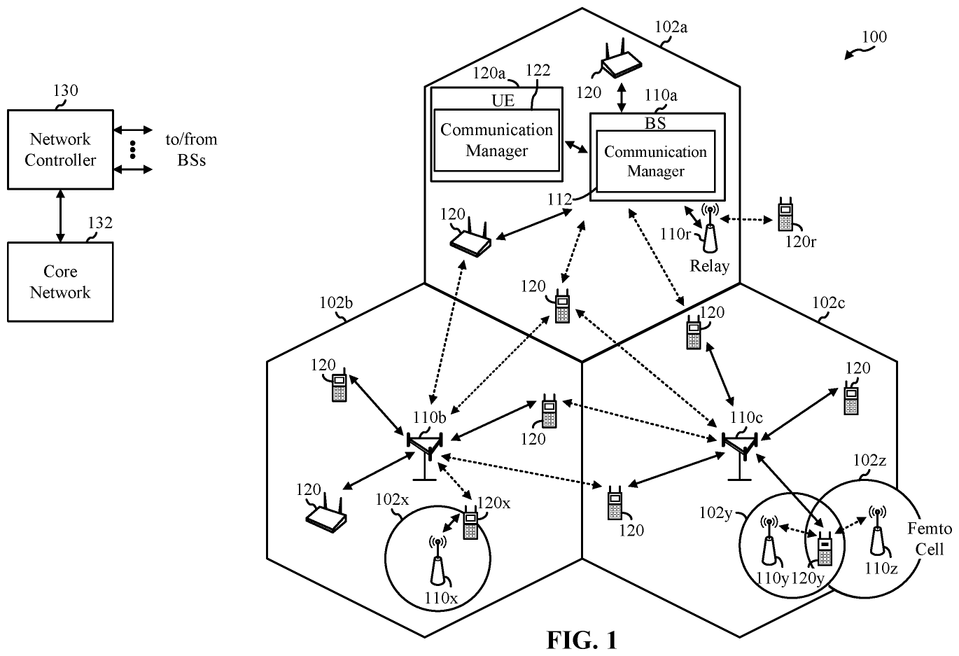

FIG. 1 illustrates an example wireless communication network 100 in which aspects of the present disclosure may be performed. For example, the wireless communication network 100 may be an NR system (e.g., a 5G NR network). As shown in FIG. 1, the wireless communication network 100 may be in communication with a core network 132. The core network 132 may be in communication with one or more base station (BSs) 110a-z (each also individually referred to herein as BS 110 or collectively as BSs 110) and/or user equipment (UE) 120a-y (each also individually referred to herein as UE 120 or collectively as UEs 120) in the wireless communication network 100 via one or more interfaces.

According to certain aspects, the BSs 110 and UEs 120 may be configured to perform wireless communications in low SNR conditions with duty cycle selection. For example, one or more of the UEs 120 may support coherent and non-coherent transmission. Similarly, one or more of the BSs 110 may be configured to configure and signal a UE 120 to switch between coherent and non-coherent transmission using one or more techniques described herein. As shown in FIG. 1, the BS 110a includes a communication manager 112 that is configured to perform one or more techniques described herein, in accordance with aspects of the present disclosure. The UE 120a includes a communication manager 122 that is configured to perform one or more techniques described herein, in accordance with aspects of the present disclosure.

A BS 110 may provide communication coverage for a particular geographic area, sometimes referred to as a “cell”, which may be stationary or may move according to the location of a mobile BS 110. In some examples, the BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS may support one or multiple cells.

The BSs 110 communicate with UEs 120 in the wireless communication network 100. The UEs 120 (e.g., 120x, 120y, etc.) may be dispersed throughout the wireless communication network 100, and each UE 120 may be stationary or mobile. Wireless communication network 100 may also include relay stations (e.g., relay station 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

A network controller 130 may be in communication with a set of BSs 110 and provide coordination and control for these BSs 110 (e.g., via a backhaul). In aspects, the network controller 130 may be in communication with a core network 132 (e.g., a 5G Core Network (5GC)), which provides various network functions such as Access and Mobility Management, Session Management, User Plane Function, Policy Control Function, Authentication Server Function, Unified Data Management, Application Function, Network Exposure Function, Network Repository Function, Network Slice Selection Function, etc.

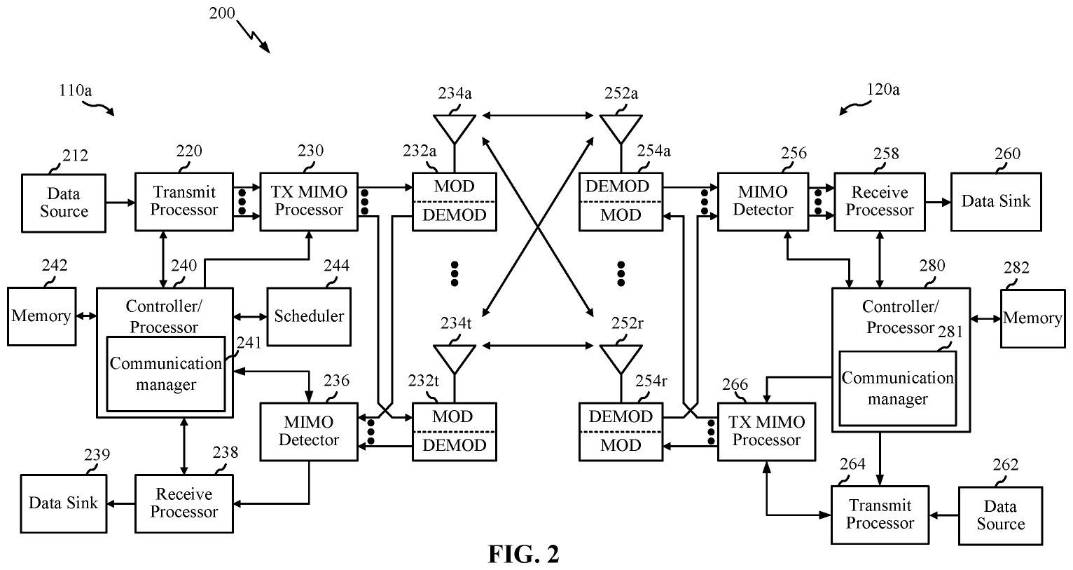

FIG. 2 illustrates example components of BS 110a and UE 120a (e.g., the wireless communication network 100 of FIG. 1), which may be used to implement aspects of the present disclosure.

At the BS 110a, a transmit processor 220 may receive data from a data source 212 and control information from a controller/processor 240. The control information may be for the physical broadcast channel (PBCH), physical control format indicator channel (PCFICH), physical hybrid automatic repeat request (HARQ) indicator channel (PHICH), physical downlink control channel (PDCCH), group common (GC) PDCCH (GC PDCCH), etc. The data may be for the physical downlink shared channel (PDSCH), etc. A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), PBCH demodulation reference signal (DMRS), and channel state information reference signal (CSI-RS). A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for orthogonal frequency division multiplexing (OFDM), etc.) to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

At the UE 120a, the antennas 252a-252r may receive the downlink signals from the BS 110a and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples (e.g., for OFDM, etc.) to obtain received symbols. A MIMO detector 256 may obtain received symbols from all the demodulators in transceivers 254a-254r, perform MIMO detection on the received symbols if applicable, and provide detected symbols. A receive processor 258 may process (e.g., demodulate, deinterleave, and decode) the detected symbols, provide decoded data for the UE 120a to a data sink 260, and provide decoded control information to a controller/processor 280.

On the uplink, at UE 120a, a transmit processor 264 may receive and process data (e.g., for the physical uplink shared channel (PUSCH)) from a data source 262 and control information (e.g., for the physical uplink control channel (PUCCH) from the controller/processor 280. The transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for single-carrier frequency division multiplexing (SC-FDM), etc.), and transmitted to the BS 110a. At the BS 110a, the uplink signals from the UE 120a may be received by the antennas 234, processed by the demodulators in transceivers 232a-232t, detected by a MIMO detector 236 if applicable, and further processed by a receive processor 238 to obtain decoded data and control information sent by the UE 120a. The receive processor 238 may provide the decoded data to a data sink 239 and the decoded control information to the controller/processor 240.

The memories 242 and 282 may store data and program codes for BS 110a and UE 120a, respectively. A scheduler 244 may schedule UEs for data transmission on the downlink and/or uplink.

Antennas 252, processors 266, 258, 264, and/or controller/processor 280 of the UE 120a and/or antennas 234, processors 220, 230, 238, and/or controller/processor 240 of the BS 110a may be used to perform the various techniques and methods described herein. For example, as shown in FIG. 2, the controller/processor 240 of the BS 110a has a communications manager 241 that configures and signals a UE to switch between coherent and non-coherent transmission in certain conditions, according to aspects described herein. As shown in FIG. 2, the controller/processor 280 of the UE 120a has a communications manager 281 that switches between coherent and non-coherent transmission in certain conditions, according to aspects described herein. Although shown at the controller/processor, other components of the UE 120a and BS 110a may be used to perform the operations described herein.

NR may utilize OFDM with a cyclic prefix (CP) on the uplink and downlink. NR may support half-duplex operation using time division duplexing (TDD). OFDM and SC-FDM partition the system bandwidth into multiple orthogonal subcarriers, which are also commonly referred to as tones, bins, etc. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers. The system bandwidth may also be partitioned into subbands. For example, a subband may cover multiple RBs. NR may support a base subcarrier spacing (SCS) of 15 kilohertz (kHz) and other SCS may be defined with respect to the base SCS (e.g., 30 kHz, 60 kHz, 120 kHz, 240 kHz, etc.).

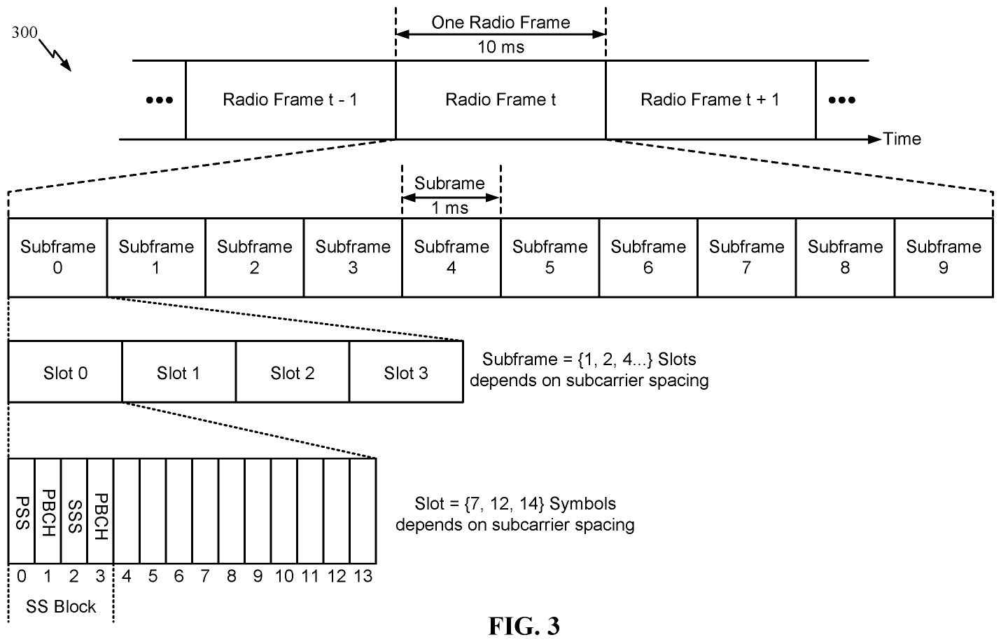

FIG. 3 is a diagram showing an example of a frame format 300 for NR. The transmission timeline for each of the downlink and uplink may be partitioned into units of radio frames. Each radio frame may have a predetermined duration (e.g., 10 ms) and may be partitioned into 10 subframes, each of 1 ms, with indices of 0 through 9. Each subframe may include a variable number of slots (e.g., 1, 2, 4, 8, 16, . . . slots) depending on the SCS. Each slot may include a variable number of symbol periods (e.g., 7, 12, or 14 symbols) depending on the SCS. The symbol periods in each slot may be assigned indices. A sub-slot structure may refer to a transmit time interval having a duration less than a slot (e.g., 2, 3, or 4 symbols). Each symbol in a slot may be configured for a link direction (e.g., DL, UL, or flexible) for data transmission and the link direction for each subframe may be dynamically switched. The link directions may be based on the slot format. Each slot may include DL/UL data as well as DL/UL control information.

In NR, a synchronization signal block (SSB) is transmitted. In certain aspects, SSBs may be transmitted in a burst where each SSB in the burst corresponds to a different beam direction for UE-side beam management (e.g., including beam selection and/or beam refinement). The SSB includes a PSS, a SSS, and a two symbol PBCH. The SSB can be transmitted in a fixed slot location, such as the symbols 0-3 as shown in FIG. 3. The PSS and SSS may be used by UEs for cell search and acquisition. The PSS may provide half-frame timing, the SSS may provide the CP length and frame timing. The PSS and SSS may provide the cell identity. The PBCH carries some basic system information, such as downlink system bandwidth, timing information within radio frame, SS burst set periodicity, system frame number, etc. The SSBs may be organized into SS bursts to support beam sweeping. Further system information such as, remaining minimum system information (RMSI), system information blocks (SIBs), other system information (OSI) can be transmitted on a physical downlink shared channel (PDSCH) in certain subframes. The SSB can be transmitted up to sixty-four times, for example, with up to sixty-four different beam directions for mmWave. The multiple transmissions of the SSB are referred to as a SS burst set. SSBs in an SS burst set may be transmitted in the same frequency region, while SSBs in different SS bursts sets can be transmitted at different frequency regions.

In some cases, one or more devices may operate in (or otherwise be subjected to) relatively low SNR conditions. Low SNR conditions may present a technical challenge to the overall performance of a wireless communication network as well as to the performance of wireless communication devices, such as low-cost energy constrained IoT devices, as an illustrative, non-limiting example. Such low SNR conditions may occur under high pathloss or wideband transmission scenarios where the received energy per spectrum unit (in frequency) is low (e.g., below a threshold) under a fixed transmit power. In certain cases, acquiring reliable channel state information (CSI) at the receiver may be problematic at relatively low SNR conditions. As a result, channel estimation quality may be limited at low SNR, which may result in significant performance degradation in demodulation/decoding.

It may be shown that, at relatively low SNR, non-coherent transmission without sending pilots (e.g., DMRS) (and without any CSI acquisition at the receiver) may result in better demodulation/decoding performance than coherent transmission (e.g., pilot-based transmission, such as DMRS-based transmission). For example, transmission schemes where the transmit power is concentrated in time and/or frequency may result in better demodulation/decoding performance in low SNR conditions without any CSI acquisition at the receiver than coherent transmission. As used herein, a transmission or transmission scheme where the transmit power is concentrated in time and/or frequency (e.g., the transmit power is non-uniformly spread over the bandwidth) may be referred to as an impulsive, peaky, or flash transmission.

Accordingly, it may be advantageous for a user equipment (UE), which can support coherent transmission and non-coherent transmission, to switch from coherent transmission to non-coherent transmission in low SNR conditions.

Example Low SNR Operation with Duty Cycle Selection

Aspects of the present disclosure provide apparatus, methods, processing systems, and computer readable mediums that allow for operation in low SNR conditions with duty cycle selection. More specifically, in certain aspects described herein, operating in low SNR conditions may include switching between coherent transmissions (e.g., that include pilots, such as DMRS) and non-coherent transmissions (e.g., without pilots, such as DMRS) in low SNR conditions.

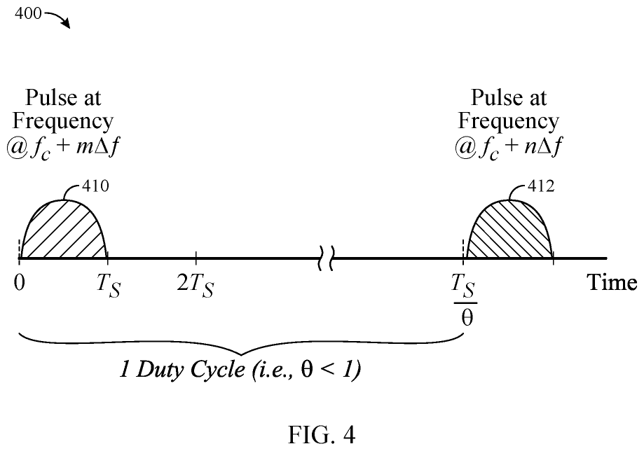

In certain aspects, the non-coherent transmissions may include peaky transmissions that are concentrated in time and/or frequency (referred to herein as peaky-based non-coherent transmissions). Peaky-based non-coherent transmissions may be performed by applying a duty cycle so that the transmission lasts for a fraction of time, and adjusting the peak transmission power proportionately. FIG. 4 illustrates a reference example of a peaky-based non-coherent transmission 400, according to certain aspects of the present disclosure. As shown, the peaky-based non-coherent transmission 400 may include one or more pulses (e.g., pulse 410, pulse 412, etc.), where each pulse is transmitted with a duty cycle of θ and a peak power of P/θ, where θ<1, P is the average power and P/θ>P. This means that each of the consecutive pulses may be transmitted after a time duration of T/θ where T is the pulse duration. Each pulse may also be concentrated in frequency where the peak power of P/θ is non-uniformly spread over the bandwidth allocated to the UE for the transmission. For example, as shown in FIG. 4, pulse 410 is transmitted at f_{c}+mΔf and pulse 412 is transmitted at f_{c}+nΔf, where f_{c} is the center frequency, Δf is the subcarrier spacing, and n>m.

In certain aspects, a network entity (e.g., BS 110a) may be configured to manage, over a period of time, the transmit scenario for the UE which may involve determining whether a UE (e.g., 120a) switches from coherent transmission to non-coherent transmission, whether the UE switches from non-coherent transmission to coherent transmission, or a combination thereof. As part of managing the transmit scenario for the UE, the network entity may configure one or more parameters of the coherent transmission or non-coherent transmission.

The network entity may manage the transmit scenario, based on QoS targets of the UE, channel conditions (e.g., delay spread, maximum Doppler spread, received power, transmission bandwidth, subcarrier spacing, etc.), signal strength parameter(s) of the network entity at the UE, or a combination thereof. The network entity may signal the transmit scenario decision and/or transmission parameters to the UE. After receiving the transmit scenario decision and/or transmission parameters, the UE may perform a non-coherent transmission or coherent transmission in accordance with the transmit scenario decision and/or transmission parameters.

Accordingly, as a result of the techniques described herein, the overall system performance may be improved (e.g., in terms of increased throughput, reduced latency, higher transmit power, etc.) in relatively low SNR conditions.

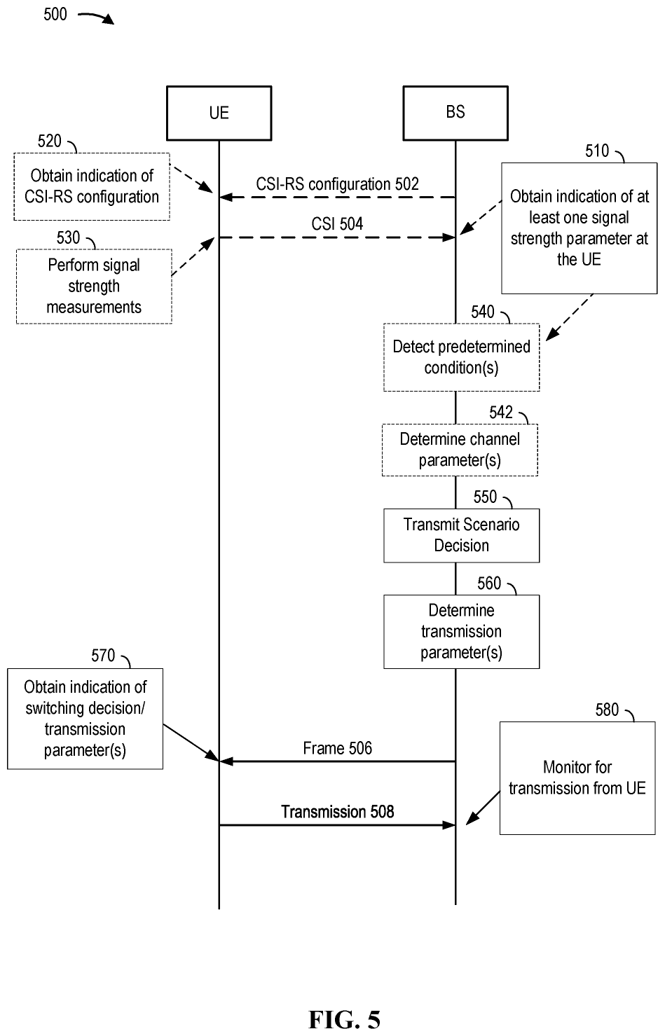

FIG. 5 depicts a call flow diagram 500 illustrating example signaling between a UE (e.g., UE 120a) and a network entity (e.g., BS 110a), in accordance with certain aspects of the present disclosure.

In certain aspects, if the network entity determines that the received power is insufficient to obtain CSI reliably at the receiver (e.g., network entity) for a given signal bandwidth (e.g., SNR is low over the specified bandwidth), then the network entity may configure the UE to switch to non-coherent transmission after checking/ensuring that the non-coherent transmission meets a satisfactory QoS (e.g., in terms of bit error rate (BER), block error rate (BLER), etc.) and/or other conditions described herein.

As indicated at 510, for example, the network entity may obtain an indication of at least one signal strength parameter associated with the network entity at the UE. The at least one signal strength parameter may include an SNR, a signal-to-interference-plus-noise-ratio (SINR), or a combination thereof. In certain aspects, the network entity, at 510, may obtain the indication of the at least one signal strength parameter from CSI transmitted from the UE.

For example, the network entity may configure one or more CSI-RS resources for the UE to use to perform one or more signal strength measurements (e.g., reference signal received power (RSRP) measurements, SINR measurements, etc.). As indicated at 520, for example, the UE may obtain an indication of a CSI-RS configuration 502 signaled from the network entity. The CSI-RS configuration may include an indication of one or more CSI-RS resources for the UE to use to perform signal strength measurements. As indicated at 530, the UE may perform one or more signal strength measurements on the CSI-RS resources and transmit CSI 504 that includes an indication of the one or more signal strength measurements.

As indicated at 550, the network entity may make a transmit scenario decision that involves determining whether the received power (of the network entity at the UE) and/or other signal quality metrics (e.g., SINR) at the UE are insufficient for coherent transmission with pilot transmission, based at least on the at least one signal strength parameter obtained at 510. In certain aspects, for example, the network entity may determine that the received power and/or other signal quality metrics are insufficient for coherent transmission with pilot transmission when a value of the at least one signal strength parameter is less than a threshold associated with a target bandwidth for transmissions from the UE. In certain aspects described herein, the network entity may determine to switch the UE from coherent transmission to non-coherent transmission when the value of the at least one signal strength parameter is less than the threshold associated with the target bandwidth for transmissions from the UE.

Compared to coherent transmission, a non-coherent transmission may not involve tracking carrier phase (e.g., no CSI estimation is performed at the receiver). Consequently, the non-coherent transmission may be transmitted without a pilot sequence (e.g., DMRS), which can lead to improved utilization of time/frequency resources compared to a coherent transmission with a pilot sequence.

In addition to, or as an alternative to, the transmit scenario decision at 550 being based on the at least one signal strength parameter, in certain aspects, the transmit scenario decision at 550 may be based on detection of one or more various conditions. As indicated at 540, for example, the network entity may detect one or more predetermined conditions associated with the value of the at least one signal strength parameter being less than a threshold associated with a target bandwidth for transmissions from the UE. Such conditions may include a radio frequency (RF) link failure or repeated cyclic redundancy check (CRC) failures (e.g., above a threshold number of failures) for certain messages transmitted to the UE, as illustrative, non-limiting examples. The network entity may detect such conditions based on indications received from a lower layer (e.g., Physical (PHY) layer) of the network entity, an upper layer of network entity, or combinations thereof. In certain aspects, upon detecting at least one of the predetermined condition(s), the network entity may determine that the value of the at least one signal strength parameter is less than a threshold associated with a target bandwidth for transmissions from the UE, and therefore, that the received power and/or other signal quality metric (e.g., SINR) are insufficient for coherent transmission (with pilot transmission).

In certain aspects, the transmit scenario decision at 550 may also involve determining whether the communication channel between the network entity and the UE is suitable for non-coherent transmission (without pilot transmission). For example, if the network entity determines that the received power and/or other signal quality metric(s) (e.g., SINR) are insufficient for coherent transmission (with pilot transmission), then the network entity may check whether the communication channel between the network entity and the UE is suitable for non-coherent transmission (without pilot transmission).

As indicated at 542, for instance, the network entity may obtain an indication of one or parameters associated with a communication channel between the network entity and the UE. One or more of the parameters may be pre-configured, indicated via signaling from the UE, set by a communication standard, or a combination thereof. Such parameters may include a delay spread, a maximum Doppler spread, received power (of the network entity) at the UE, transmission bandwidth configured for the UE, and a subcarrier spacing, as illustrative, non-limiting examples. Here, the transmit scenario decision at 550 may also include determining whether the channel parameter(s) satisfy predetermined criteria associated with non-coherent transmission. The predetermined criteria may include (i) a target duty cycle for the non-coherent transmission at the target bandwidth or (ii) a target maximum transmission power for the non-coherent transmission at the target bandwidth. For example, if the non-coherent transmission is to be a peaky-based non-coherent transmission, then the network entity may determine whether the target duty cycle that is to be applied in the time domain violates any QoS targets (e.g., delay). In addition, the network entity may determine whether the instantaneous transmission power can be increased to the target maximum transmission power, in relation to the target duty cycle, signal bandwidth, received power, etc.

In certain aspects, if the network entity determines that the channel parameter(s) satisfy the predetermined criteria associated with non-coherent transmission, then the transmit scenario decision at 550 may further include determining to switch the UE from coherent transmission (with pilot transmission) to non-coherent transmission (without pilot transmission). In certain aspects, the non-coherent transmission (without pilot transmission) may be a peaky-based non-coherent transmission. On the other hand, if the network entity determines that the channel parameter(s) do not satisfy the predetermined criteria associated with non-coherent transmission, then the transmit scenario decision at 550 may further include determining to keep the UE configured for coherent transmission.

As indicated at 560, the network entity may determine one or more transmission parameters associated with the transmit scenario decision at 550. Assuming the transmit scenario decision is to switch to a non-coherent transmission, the transmission parameters may include at least one of (i) the target bandwidth for the non-coherent transmission, (ii) the target duty cycle for the non-coherent transmission at the target bandwidth, or (iii) the target maximum transmission power for the non-coherent transmission at the target bandwidth. In some cases, the target duty cycle may be less than or equal to 1. In some cases, the target maximum transmission power for the non-coherent transmission may be greater than an average transmission power used for a transmission with a longer duration than the non-coherent transmission.

In certain aspects, the network entity may signal an indication of the transmit scenario decision as well as the transmission parameters associated with the transmit scenario decision to the UE. As indicated at 570, for example, the UE may obtain a frame 506 that includes the indication of the switching decision and/or transmission parameter(s).

The UE may send a transmission 508 to the network entity in accordance with the transmit scenario decision and transmit parameter(s). For example, the transmission 508 may be a non-coherent transmission (without pilot transmission) or a coherent transmission (with pilot transmission). As indicated at 580, for example, the network entity may monitor for the transmission 508 from the UE.

In certain aspects, the network entity, at 560, may be configured to adjust one or more transmission parameters for a transmit scenario in relatively low SNR conditions. The network entity may adjust transmission parameter(s) for a coherent transmission in relatively low SNR conditions or a non-coherent transmission in relatively low SNR conditions. In one reference example, the network entity may adjust the transmission bandwidth to better leverage a coherent or non-coherent transmission under low SNR conditions. In this example, if the network entity determines that a coherent transmission (with pilot transmission and CSI estimation at the receiver) cannot meet QoS targets of the UE, then the network entity may configure the UE to (i) perform coherent transmission (with pilot transmission) at a lower bandwidth than a configured transmission bandwidth (e.g., by assigning less resource blocks than the configured transmission bandwidth) or (ii) perform non-coherent transmission (without pilot transmission) at a higher bandwidth than the configured transmission bandwidth (e.g., by assigning more resource blocks than the configured transmission bandwidth). The network entity may modify the transmission bandwidth until the value of the at least one signal strength parameter is greater than the threshold associated with the target bandwidth. In certain cases, assigning less resource blocks to achieve the lower bandwidth may increase the “received power per hertz” (assuming a fixed transmit power). In certain cases, assigning more resource blocks to achieve the higher bandwidth may decrease the “received power per hertz” (assuming a fixed transmit power).

Note that while certain aspects may allow the network entity to configure the UE to perform a coherent transmission with an adjusted transmission bandwidth, this configuration option may not be suitable for certain communication scenarios. For example, in certain cases, the network entity may have to configure the UE to perform a non-coherent transmission since non-zero data rates under coherent transmission may be limited to small bandwidths (e.g., 100 kHz of bandwidth if the received power (P) normalized by the noise power spectral density (PSD) (P/N₀) is 100 Hz for a channel spread of τₘₐₓνₘₐₓ≈0.001).

Note that, in certain aspects, the network entity may periodically assess whether it needs to update its transmit scenario decision (e.g., at 550) and/or transmission parameter(s) (e.g., at 560) for the UE. That is, the network entity may perform one or more of the blocks 510, 540, and/or 542 periodically over time in order to determine whether to update the transmit scenario decision at 550 and/or transmission parameter(s) at 560.

In one reference example, the network entity may assess if it needs to update the interference management strategy due to non-coherent transmission since non-coherent transmission may lead to peaky-based transmissions (e.g., not all the symbol occasions and subcarriers may be used at the same time even though all these subcarriers or symbol occasions may be assigned to the served UE). In this example, the network entity may configure CSI-RS resources (e.g., CSI-RS configuration 502) to perform/repeat interference measurements once the transmit scenario decision switches to non-coherent transmission.

Additionally or alternatively, in one reference example, the network entity may evaluate channel parameters, such as subcarrier spacing, channel delay spread, maximum Doppler spread, received power (e.g., RSRP), etc., when determining whether to switch the UE to coherent transmission or non-coherent transmission. In this example, the network entity may check if there is an existing reference signal (RS) measurement with adequate quasi colocation (QCL) relation (e.g., Types A/B/C) to the transmission to assess the impact of these parameters.

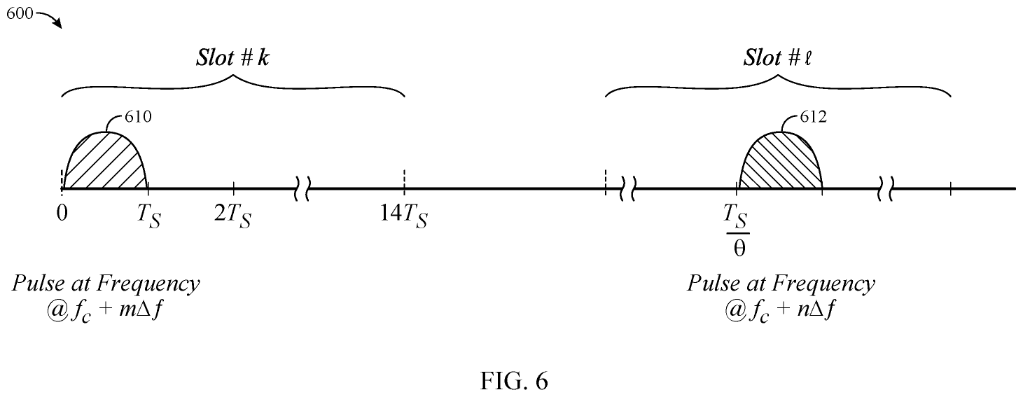

In some scenarios, depending on the duty cycle (e.g., for θ<1/14=0.0714), the network entity may configure a slot aggregation parameter for the non-coherent transmission (e.g., the non-coherent transmission may have to finish in multiple slots). Consider FIG. 6 which depicts an example scenario in which a non-coherent transmission 600 occurs across multiple slots, according to certain aspects of the present disclosure. Here, the non-coherent transmission 600 is a peaky-based non-coherent transmission with pulse 610 and pulse 612. Pulse 610 is transmitted in slot #k at f_{c}+mΔf and pulse 612 is transmitted in slot #1 at f_{c}+nΔf, where f_{c} is the center frequency, Δf is the subcarrier spacing, n>m, and l>k. This sufficiently low duty cycle scenario depicted in FIG. 6 may be handled dynamically via downlink control information (DCI) or over radio resource control (RRC) messages semi-statically by designing a time pattern across multiple slots.

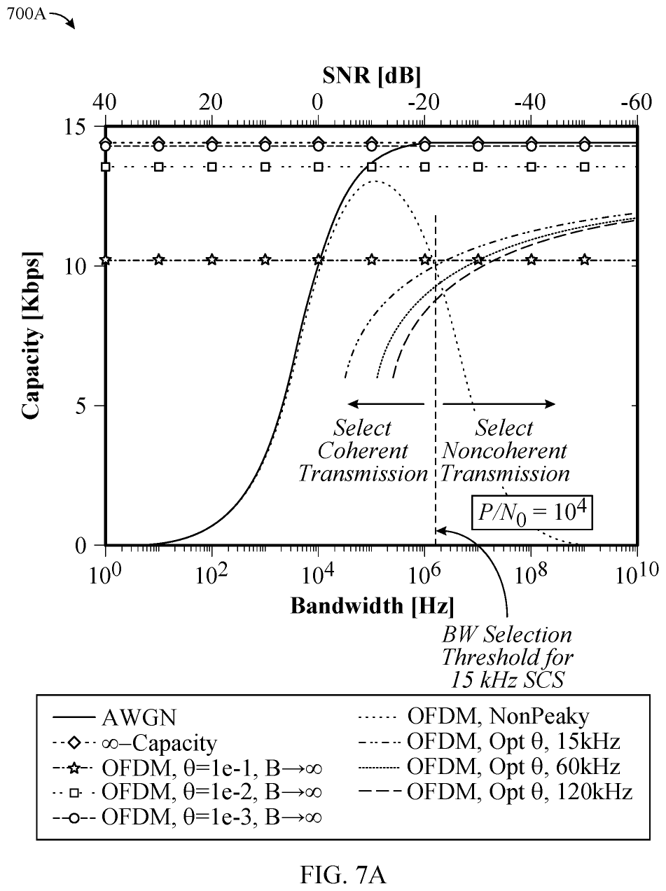

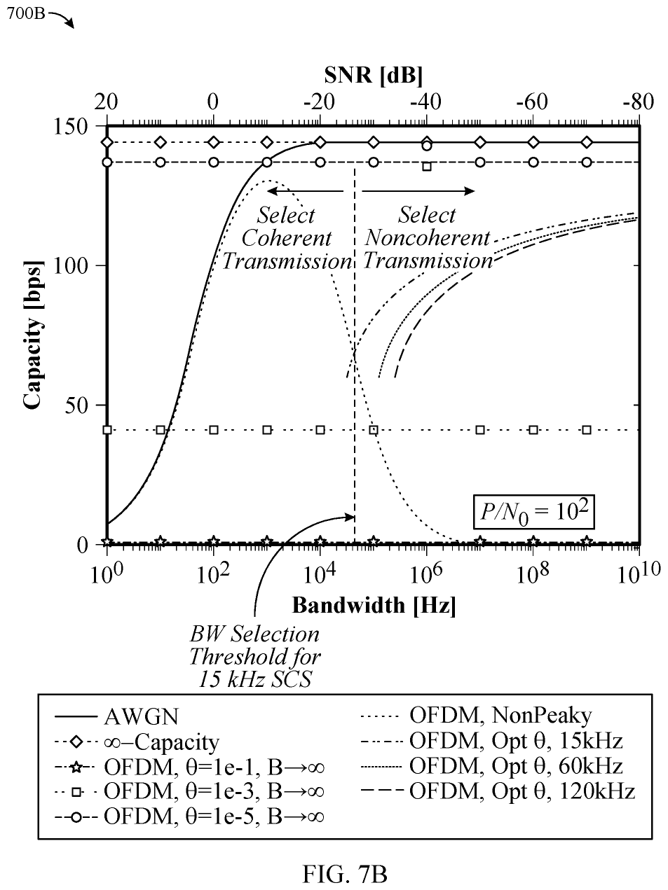

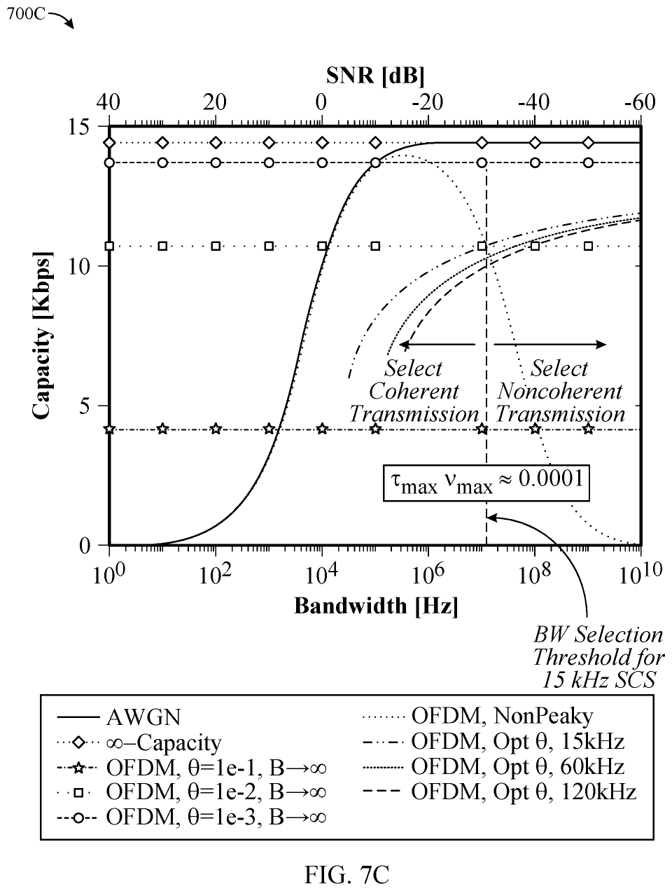

FIGS. 7A, 7B, and 7C illustrate graphs 700A, 700B, and 700C, respectively, of transmit scenario selection between coherent transmission and non-coherent transmission based on various parameters, according to certain aspects of the present disclosure. In particular, graph 700A depicts a bandwidth selection threshold for the transmit scenario selection, assuming a cyclic prefix OFDM (CP-OFDM) waveform with 15 kHz subcarrier spacing, 0.5 microsecond (μs) delay spread, channel spread (τmaxνmax) of approximately 0.001, and received power normalized by noise PSD (P/N₀) approximately equal to 10⁴ s⁻¹. Graph 700B depicts a bandwidth selection threshold for the transmit scenario selection, assuming a CP-OFDM waveform with 15 kHz subcarrier spacing, 0.5 us delay spread, τₘₐₓνₘₐₓ≈0.001, and P/N₀≈10² s⁻¹. Graph 700C depicts a bandwidth selection threshold for the transmit scenario selection, assuming a CP-OFDM waveform with 15 kHz subcarrier spacing, 0.5 μs delay spread, τₘₐₓνₘₐₓ≈0.0001, and P/N₀≈10⁴ s⁻¹.

### Duty Cycle Selection for Non-Coherent Transmission

In certain cases, in order to perform certain types of non-coherent transmission, such as peaky-based non-coherent transmissions, the transmitter (e.g., UE) may have to apply a duty cycle such that the transmission occurs for a fraction of time, and the peak transmit power is increased in proportion with the inverse duty cycle. One potential drawback, however, to selecting a duty cycle is that, because there may be a constraint on the peak transmit power in practice, the peak transmit power may not be increased to an arbitrary value that is solely determined by the duty cycle. In addition, the duty cycle value cannot be selected arbitrarily small if the allocated bandwidth is not infinitely large, since this scenario may limit the entropy associated with tone selection.

According to certain aspects, when the network entity determines to switch the UE to non-coherent transmission, the network entity may be configured to select a duty cycle for the non-coherent transmission and signal the selected duty cycle to the UE. In certain aspects, the network entity may select a duty cycle for the non-coherent transmission, based on the available bandwidth, available or allowed peak transmit power, or a combination thereof. Referring again to FIG. 5, the network entity may perform the duty cycle selection at 560 of the call flow diagram 500.

For example, at 550, if the network entity determines that the received power and/or other signal quality metrics (e.g., SINR) are insufficient for coherent transmission (with pilot transmission), then the network entity may determine to switch the UE to non-coherent transmission (without pilot transmission). For a peaky-based non-coherent transmission, the network entity may (i) apply a duty cycle to the transmission so that the transmission occurs for a fraction of time and (ii) increase the peak transmit power for the transmission (in proportion to the inverse of the duty cycle), so that the transmit power of the non-coherent transmission is concentrated over time and also over frequency (e.g., via selecting a few tones at a time).

In some cases, the optimal (e.g., minimum) duty cycle may be a function of the signal bandwidth (or transmission bandwidth) allocated to the UE being served. In such cases, the optimal duty cycle may be selected based on the available bandwidth. For example, the capacity of the peaky-based non-coherent transmission (c_{noCSI}^{peaky}) may be represented using the following expression:

$${c}_{noCSI}^{peaky} = \frac{P {σ}_{H}^{2}}{{N}_{0}} - \frac{θ}{T} log ( 1 + \frac{T}{θ} \frac{P {σ}_{H}^{2}}{{N}_{0}} ) ( nats ) \qquad ( 1 )$$

where P is the transmit power, T is the transmit duration, N₀ is the noise PSD, σ_{H}² is the power loss during the propagation (i.e., path-loss), and θ is the duty cycle. In some cases, peaky the capacity of the peaky-based non-coherent transmission (c_{noCSI}^{peaky}) may be maximized when

$$\frac{θ}{T} log ( 1 + \frac{T}{θ} \frac{P {σ}_{H}^{2}}{{N}_{0}} )$$

in (1) is zero, which may be achieved with a very small duty cycle value. To approach this maximum capacity, however, a very large (e.g. infinite) bandwidth may have to be used, such that the number of tones (e.g., subcarriers) K becomes infinitely large (e.g., K→∞). For example, K may become infinitely large due to the respective noise-free data rate (R) having the following relationship:

$$R = \frac{log K}{T / θ} \leq {c}_{noCSI}^{peaky} \qquad ( 2 )$$

In some cases, the expressions in (1) and (2) may represent a tradeoff for the selection of the optimal (e.g., minimum) duty cycle for bandwidth-limited scenarios. For example, for large duty cycles, the achievable rate may be limited by the expression in (1). For small duty cycles, the achievable rate may be limited by the expression in (2) if the bandwidth is limited. In addition, the selection of the optimal duty cycle may also be based on the bandwidth for a single tone (e.g., subcarrier spacing in OFDM) for bandwidth-limited scenarios. For example, for a bandwidth of 1 MHz, the optimal duty cycle may be θ=0.116 for a subcarrier spacing of 15 kHz, and the optimal duty cycle may be θ=0.040 for a subcarrier spacing of 60 KHz.

Accordingly, in certain aspects, for bandwidth limited scenarios, the network entity may select a duty cycle for a peaky-based non-coherent transmission based on the allocated bandwidth and subcarrier spacing of the transmission. In some cases, the network entity may determine the optimal duty cycle using predefined lookup tables indicating the optimum duty cycle with respect to bandwidth and subcarrier spacing. In certain aspects, after selecting a given duty cycle, the network entity may update the selected duty cycle based on feedback from the UE indicating at least one of power measurements, decoding performance, or CRCs. In certain aspects, the network entity may also update the transmission bandwidth and/or subcarrier spacing in order to realize the optimal duty cycle. In such aspects, the network entity may use predefined lookup tables indicating the optimum duty cycle with respect to bandwidth and subcarrier spacing. The network entity may also take into account other parameters, such as time delay as a result of the duty cycle and limitations on peak power increases, when updating the transmission bandwidth and/or subcarrier spacing.

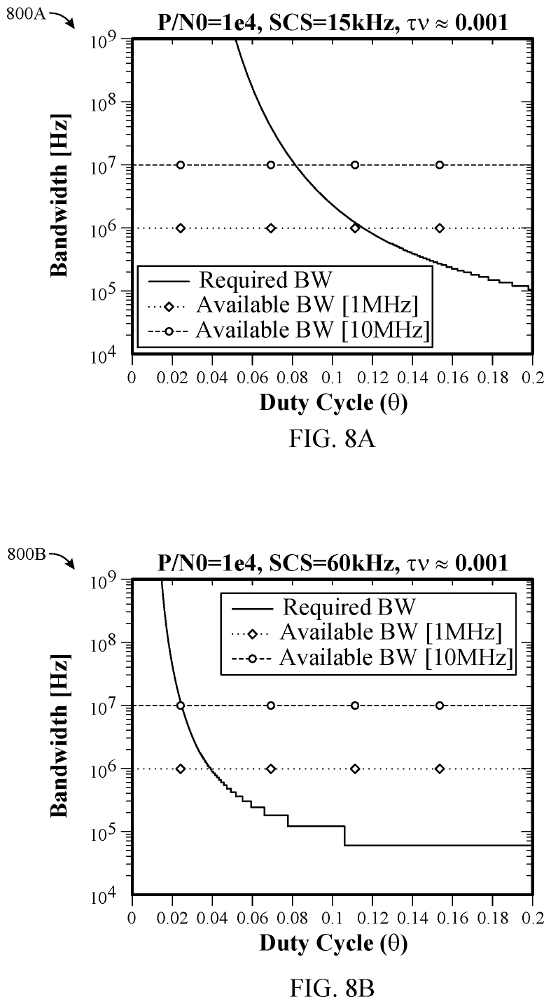

FIGS. 8A and 8B illustrate graphs 800A and 800B, respectively, of duty cycle selection for non-coherent transmission based on various parameters, according to certain aspects of the present disclosure. As shown in graph 800A, for example, assuming a CP-OFDM waveform with a 15 kHz subcarrier spacing, a 0.5 us delay spread, τₘₐₓνₘₐₓ≈0.001, and P/N₀≈10⁴ s⁻¹, the optimal duty cycle may be θ=0.116 for a bandwidth of 1 MHz and θ=0.081 for a bandwidth of 10 MHz. As shown in graph 800B, assuming a CP-OFDM waveform with a 60 kHz subcarrier spacing, a 0.5 us delay spread, τₘₐₓνₘₐₓ≈0.001, and P/N₀≈10⁴ s⁻¹, the optimal duty cycle may be 0=0.040 for a bandwidth of 1 MHz and 0=0.025 for a bandwidth of 10 MHz.

In certain cases, the optimal (e.g. minimum) duty cycle may be based on the allowable peak power. For example, as noted above, the capacity of the peaky-based non-coherent transmission (c_{noCSI}^{peaky}) may be maximized when

$$\frac{θ}{T} log ( 1 + \frac{T}{θ} \frac{P {σ}_{H}^{2}}{{N}_{0}} )$$

in (1) is zero, which may be achieved with a very small duty cycle value. However, selecting a small duty cycle may also lead to a larger instantaneous transmit power (such that P/θ>P since θ<1) which may or may not be allowed by the UE. Accordingly, in certain aspects, for bandwidth limited scenarios, the network entity may select a duty cycle for a peaky-based non-coherent transmission based on the allowable peak power.

In one aspect, the network entity may select an optimal (e.g., minimum) duty cycle for the non-coherent transmission based on the allowable peak power, such that P/θ does not exceed Pₘₐₓ^{peak}, which is the maximum peak power allowed for the UE. In some cases, the network entity may select a small duty cycle without increasing peak power proportionately. For example, in such cases, the selected duty cycle and peak power combination may be verified (e.g., via prior analytical computations, based on UE feedback, etc.) to provide satisfactory performance (e.g., with respect to coherent transmission).

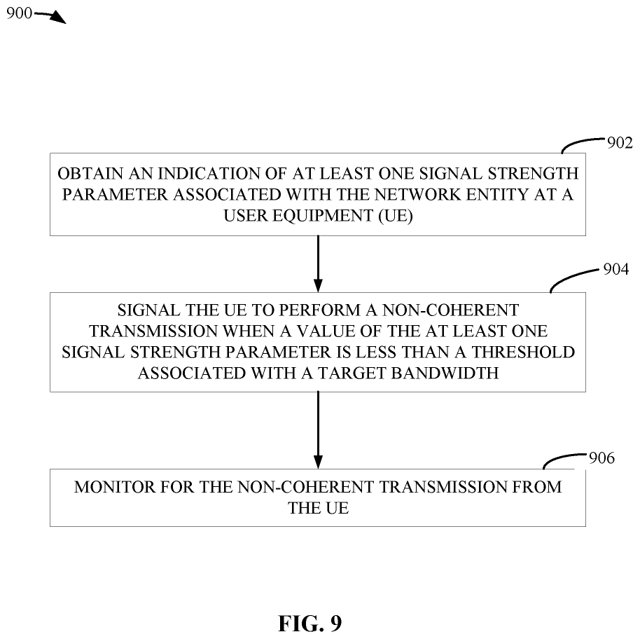

FIG. 9 is a flow diagram illustrating example operations 900 for wireless communication, in accordance with certain aspects of the present disclosure. The operations 900 may be performed, for example, by a network entity (e.g., such as the BS 110a in the wireless communication network 100). The operations 900 may be complementary to operations 1000 performed by the UE. The operations 900 may be implemented as software components that are executed and run on one or more processors (e.g., controller/processor 240 of FIG. 2). Further, the transmission and reception of signals by the network entity in operations 900 may be enabled, for example, by one or more antennas (e.g., antennas 234 of FIG. 2). In certain aspects, the transmission and/or reception of signals by the network entity may be implemented via a bus interface of one or more processors (e.g., controller/processor 240) obtaining and/or outputting signals.

Operations 900 may begin, at 902, by obtaining an indication of at least one signal strength parameter associated with the network entity at a UE (e.g., UE 120a in the wireless communication network 100). The at least one signal strength parameter may include at least one of a SNR or a SINR.

In certain aspects, obtaining the indication of the at least one signal strength parameter, at 902, may include receiving CSI associated with a set of CSI-RS resources configured for the UE, where the CSI includes the at least one signal strength parameter.

At 904, the network entity may signal the UE to perform a non-coherent transmission when a value of the at least one signal strength parameter is less than a threshold associated with a target bandwidth.

At 906, the network entity may monitor for the non-coherent transmission from the UE.

In certain aspects, the operations 900 may further include detecting at least one of (i) an RF link failure between the network entity and the UE or (ii) one or more CRC failures associated with one or more messages transmitted to the UE. In such cases, responsive to the detection, the network entity may determine that the value of the at least one signal strength parameter is less than the threshold.

In certain aspects, the operations 900 may further include obtaining an indication of one or more parameters associated with a communication channel between the network entity and the UE. In such aspects, signaling the UE to perform the non-coherent transmission, at 904, may occur after determining that the one or more parameters satisfy one or more second conditions. The one or more parameters may include at least one of a delay spread, a maximum Doppler spread, received power, transmission bandwidth, or a subcarrier spacing. The one or more second conditions may include at least one of (i) a target duty cycle for the non-coherent transmission at the target bandwidth or (ii) a target maximum transmission power for the non-coherent transmission at the target bandwidth. In some aspects, the target duty cycle is less than or equal to 1. In some aspects, the target maximum transmission power for the non-coherent transmission is greater than an average transmission power used for a transmission with a longer duration that the non-coherent transmission.

In some aspects, signaling the UE to perform the non-coherent transmission, at 904, may include signaling an indication of at least one of the target bandwidth, the target duty cycle for the non-coherent transmission at the target bandwidth, or the target maximum transmission power for the non-coherent transmission at the target bandwidth. In some aspects, signaling the UE to perform the non-coherent transmission, at 904, may include signaling an indication of a slot aggregation parameter to be used for the non-coherent transmission.

In certain aspects, the operations 900 may further include modifying the target bandwidth until the value of the at least one signal strength parameter is greater than the threshold, and signaling the UE to perform the coherent transmission at the modified target bandwidth.

In certain aspects, the operations 900 may further include selecting a value of a target duty cycle for the non-coherent transmission, from a plurality of predefined values of the target duty cycle, based on at least one of the target bandwidth or a subcarrier spacing associated with the non-coherent transmission. In such aspects, signaling the UE to perform the non-coherent transmission, at 904, may include signaling an indication of the value of the target duty cycle to the UE.

In certain aspects, the operations 900 may further include (i) receiving feedback from the UE, (ii) updating the value of the target duty cycle after receiving the feedback, and (iii) signaling an indication of the updated value of the target duty cycle to the UE. The feedback may include at least one of one or more power measurements, an indication of decoding performance of messages from the network entity, or a result of one or more CRCs.

In certain aspects, the operations 900 may further include selecting at least one of (i) a value of the target bandwidth from a plurality of predefined values of the target bandwidth or (ii) a value of the subcarrier spacing from a plurality of predefined values of the subcarrier spacing.

In certain aspects, the operations 900 may further include selecting a value of a target duty cycle for the non-coherent transmission, based on an allowable maximum transmission power for the non-coherent transmission. In such aspects, signaling the UE to perform the non-coherent transmission, at 904, may include signaling an indication of the value of the target duty cycle to the UE.

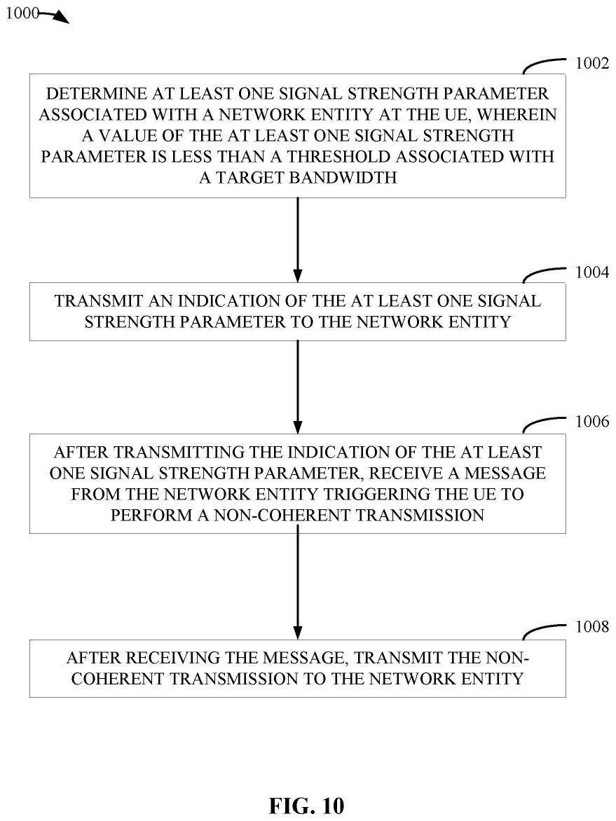

FIG. 10 is a flow diagram illustrating example operations 1000 for wireless communication, in accordance with certain aspects of the present disclosure. The operations 1000 may be performed, for example, by a UE (e.g., such as the UE 120a in the wireless communication network 100). The operations 1000 may be implemented as software components that are executed and run on one or more processors (e.g., controller/processor 280 of FIG. 2). Further, the transmission and reception of signals by the UE in operations 1000 may be enabled, for example, by one or more antennas (e.g., antennas 252 of FIG. 2). In certain aspects, the transmission and/or reception of signals by the UE may be implemented via a bus interface of one or more processors (e.g., controller/processor 280) obtaining and/or outputting signals.

Operations 1000 may begin, at 1002, by determining at least one signal strength parameter associated with a network entity at the UE. A value of the at least one signal strength parameter is less than a threshold associated with a target bandwidth. The at least one signal strength parameter may include at least one of a SNR or a SINR.

At 1004, the UE transmits an indication of the at least one signal strength parameter to the network entity.

At 1006, after transmitting the indication of the at least one signal strength parameter, the UE receives a message from the network entity triggering the UE to perform a non-coherent transmission.

At 1008, after receiving the message, the UE transmits the non-coherent transmission to the network entity.

In certain aspects, transmitting the indication of the at least one signal strength parameter, at 1004, may include transmitting CSI associated with a set of CSI-RS resources configured for the UE, where the CSI includes the at least one signal strength parameter.

In certain aspects, the message received at 1006 may include an indication of at least one of (i) the target bandwidth, (ii) a target duty cycle for the non-coherent transmission at the target bandwidth or (iii) a target maximum transmission power for the non-coherent transmission at the target bandwidth. In such aspects, the UE may transmit the non-coherent transmission, at 1008, based on at least one of (i) the target bandwidth, (ii) the target duty cycle or (iii) the target maximum transmission power.

In certain aspects, the message received at 1006 may include an indication of at least one of a slot aggregation parameter to be used for the non-coherent transmission. In such aspects, the UE may transmit the non-coherent transmission, at 1008, based on the slot aggregation parameter.

In certain aspects, the operations 1000 may further include (i) receiving an indication of a modified target bandwidth, where the modified target bandwidth is associated with a value of the at least one signal strength parameter being greater than a threshold, and (ii) transmitting another non-coherent transmission at the modified target bandwidth.

In certain aspects, the operations 1000 may further include (i) receiving an indication of a value of a target duty cycle for the non-coherent transmission, where the value of the target duty cycle is based on at least one of the target bandwidth or a subcarrier spacing associated with the non-coherent transmission, and (ii) transmitting the non-coherent transmission according to the value of the target duty cycle.

In certain aspects, the operations 1000 may further include: transmitting feedback including at least one of (i) one or more power measurements, (ii) an indication of decoding performance of messages from the network entity, or (iii) a result of one or more CRCs; receiving an indication of an updated value of the target duty cycle; and transmitting another non-coherent transmission according to the updated value of the target duty cycle. In such aspects, the operations 1000 may further include receiving an indication of at least one of: (i) a value of the target bandwidth from a plurality of predefined values of the target bandwidth or (ii) a value of the subcarrier spacing from a plurality of predefined values of the subcarrier spacing, where the other non-coherent transmission is transmitted according to at least one of the value of the target bandwidth or the value of the subcarrier spacing.

In certain aspects, the operations 1000 may further include receiving an indication of a value of a target duty cycle for the non-coherent transmission, where the value of the target duty cycle is based on an allowable maximum transmission power for the non-coherent transmission; and transmitting the non-coherent transmission according to the value of the target duty cycle.

### Example Communications Devices

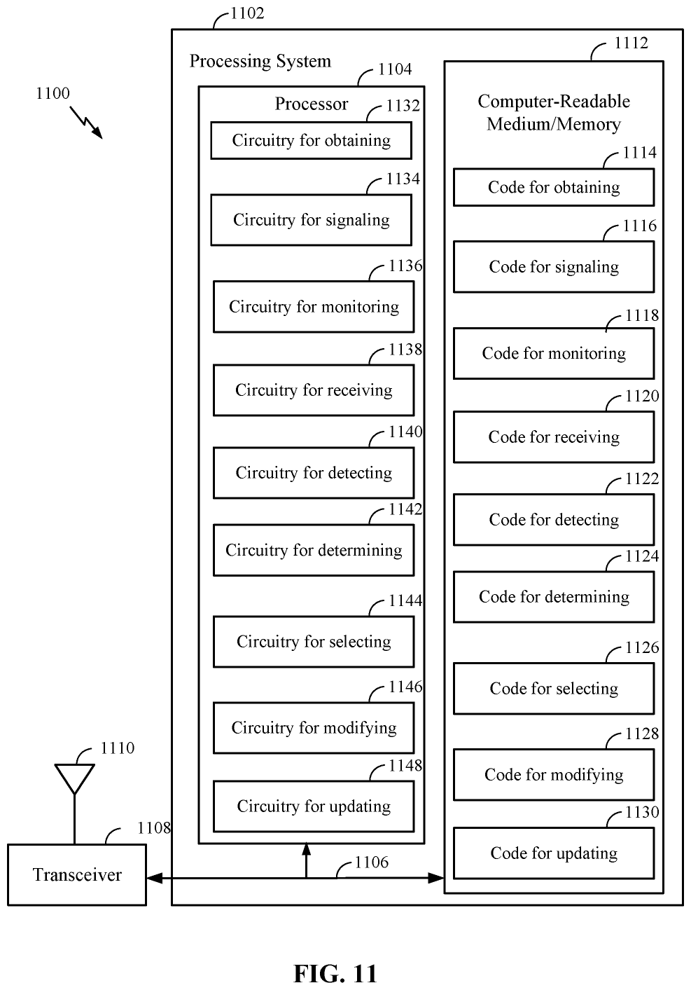

FIG. 11 illustrates a communications device 1100 that may include various components (e.g., corresponding to means-plus-function components) configured to perform operations for the techniques disclosed herein, such as the operations illustrated in FIG. 9. The communications device 1100 includes a processing system 1102 coupled to a transceiver 1108. The transceiver 1108 is configured to transmit and receive signals for the communications device 1100 via an antenna 1110, such as the various signals as described herein. The processing system 1102 may be configured to perform processing functions for the communications device 1100, including processing signals received and/or to be transmitted by the communications device 1100.

The processing system 1102 includes a processor 1104 coupled to a computer-readable medium/memory 1112 via a bus 706. In certain aspects, the computer-readable medium/memory 712 is configured to store instructions (e.g., computer-executable code) that when executed by the processor 1104, cause the processor 1104 to perform the operations illustrated in FIG. 9, or other operations for performing the various techniques discussed herein. In certain aspects, computer-readable medium/memory 1112 stores code for obtaining 1114, code for signaling 1116, code for monitoring 1118, code for receiving 1120, code for detecting 1122, code for determining 1124, code for selecting 1126, code for modifying 1128, and code for updating 1130. In certain aspects, the processor 1104 has circuitry configured to implement the code stored in the computer-readable medium/memory 1112. The processor 1104 includes circuitry 1132 for obtaining, circuitry 1134 for signaling, circuitry 1136 for monitoring, circuitry 1138 for receiving, circuitry 1140 for detecting, circuitry 1142 for determining, circuitry 1144 for selecting, circuitry 1146 for modifying, and circuitry 1148 for updating.

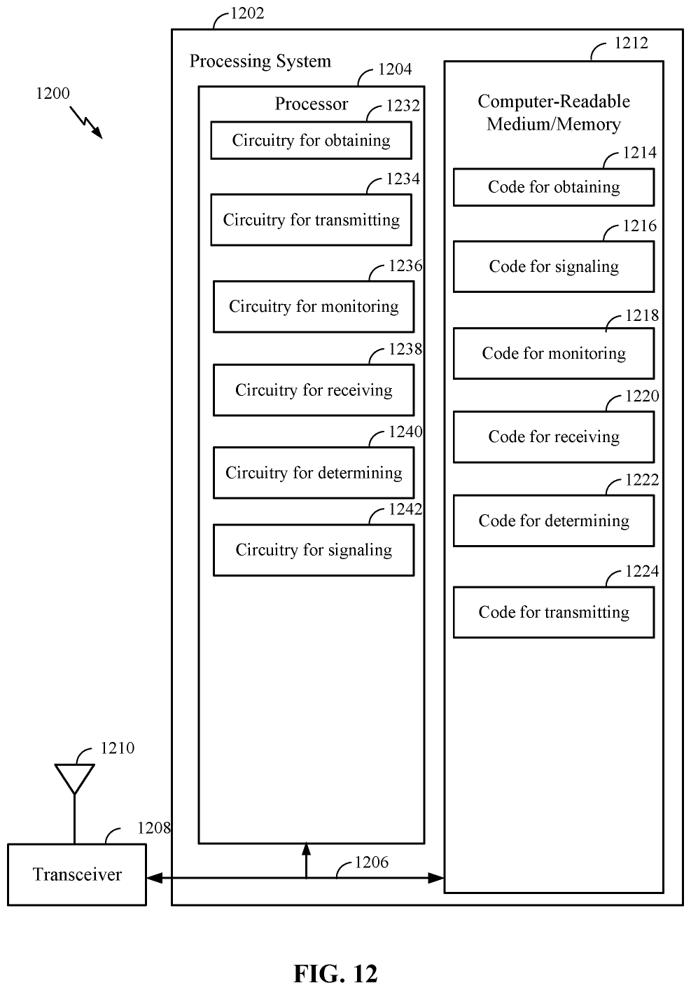

FIG. 12 illustrates a communications device 1200 that may include various components (e.g., corresponding to means-plus-function components) configured to perform operations for the techniques disclosed herein, such as the operations illustrated in FIG. 10. The communications device 1200 includes a processing system 1202 coupled to a transceiver 1208. The transceiver 1208 is configured to transmit and receive signals for the communications device 1200 via an antenna 1210, such as the various signals as described herein. The processing system 1202 may be configured to perform processing functions for the communications device 1200, including processing signals received and/or to be transmitted by the communications device 1200.

The processing system 1202 includes a processor 1204 coupled to a computer-readable medium/memory 1212 via a bus 1206. In certain aspects, the computer-readable medium/memory 1212 is configured to store instructions (e.g., computer-executable code) that when executed by the processor 1204, cause the processor 1204 to perform the operations illustrated in FIG. 10, or other operations for performing the various techniques discussed herein. In certain aspects, computer-readable medium/memory 1212 stores code for obtaining 1214, code for signaling 1216, code for monitoring 1218, code for receiving 1220, code for determining 1222, and code for transmitting 1224. In certain aspects, the processor 1204 has circuitry configured to implement the code stored in the computer-readable medium/memory 1212. The processor 1204 includes circuitry 1232 for obtaining, circuitry 1234 for transmitting, circuitry 1336 for monitoring, circuitry 1238 for receiving, circuitry 1240 for determining, and circuitry 1242 for signaling.

### EXAMPLE ASPECTS

Aspect 1: A method for wireless communication by a network entity, comprising: obtaining an indication of at least one signal strength parameter associated with the network entity at a user equipment (UE); signaling the UE to perform a non-coherent transmission when a value of the at least one signal strength parameter is less than a threshold associated with a target bandwidth; and monitoring for the non-coherent transmission from the UE.

Aspect 2: The method of Aspect 1, wherein the at least one signal strength parameter comprises at least one of a signal-to-noise ratio (SNR) or a signal-to-interference-plus-noise ratio (SINR).

Aspect 3: The method according to any of Aspects 1-2, wherein obtaining the indication of the at least one signal strength parameter comprises receiving channel state information (CSI) associated with a set of channel state information reference signal (CSI-RS) resources configured for the UE, wherein the CSI comprises the at least one signal strength parameter.

Aspect 4: The method according to any of Aspects 1-3, further comprising: detecting at least one of (i) a radio frequency (RF) link failure between the network entity and the UE or (ii) one or more cyclic redundancy check (CRC) failures associated with one or more messages transmitted to the UE; and responsive to the detection, determining that the value of the at least one signal strength parameter is less than the threshold.

Aspect 5: The method according to any of Aspects 1-4, further comprising obtaining an indication of one or more parameters associated with a communication channel between the network entity and the UE, wherein signaling the UE to perform the non-coherent transmission occurs after determining that the one or more parameters satisfy one or more second conditions.

Aspect 6: The method of Aspect 5, wherein the one or more parameters comprise at least one of a delay spread, a maximum Doppler spread, received power, transmission bandwidth, or a subcarrier spacing.

Aspect 7: The method according to any of Aspects 5-6, wherein the one or more second conditions comprise at least one of (i) a target duty cycle for the non-coherent transmission at the target bandwidth or (ii) a target maximum transmission power for the non-coherent transmission at the target bandwidth.

Aspect 8: The method of Aspect 7, wherein the target duty cycle is less than or equal to 1.

Aspect 9: The method according to any of Aspects 7-8, wherein the target maximum transmission power for the non-coherent transmission is greater than an average transmission power used for a transmission with a longer duration than the non-coherent transmission.

Aspect 10: The method according to any of Aspects 7-9, wherein signaling the UE to perform the non-coherent transmission comprises signaling an indication of at least one of the target bandwidth, the target duty cycle for the non-coherent transmission at the target bandwidth, or the target maximum transmission power for the non-coherent transmission at the target bandwidth.

Aspect 11: The method according to any of Aspects 1-10, wherein signaling the UE to perform the non-coherent transmission further comprises signaling an indication of a slot aggregation parameter to be used for the non-coherent transmission.

Aspect 12: The method according to any of Aspects 1-11, further comprising: modifying the target bandwidth until the value of the at least one signal strength parameter is greater than the threshold; and signaling the UE to perform the coherent transmission at the modified target bandwidth.

Aspect 13: The method according to any of Aspects 1-12, further comprising selecting a value of a target duty cycle for the non-coherent transmission, from a plurality of predefined values of the target duty cycle, based on at least one of the target bandwidth or a subcarrier spacing associated with the non-coherent transmission, wherein signaling the UE to perform the non-coherent transmission comprises signaling an indication of the value of the target duty cycle to the UE.

Aspect 14: The method of Aspect 13, further comprising: receiving feedback from the UE; updating the value of the target duty cycle after receiving the feedback, wherein the feedback comprises at least one of (i) one or more power measurements, (ii) an indication of decoding performance of messages from the network entity, or (iii) a result of one or more cyclic redundancy checks (CRCs); and signaling an indication of the updated value of the target duty cycle to the UE.

Aspect 15: The method according to any of Aspects 13-14, further comprising selecting at least one of (i) a value of the target bandwidth from a plurality of predefined values of the target bandwidth or (ii) a value of the subcarrier spacing from a plurality of predefined values of the subcarrier spacing.

Aspect 16: The method according to any of Aspects 1-12, further comprising selecting a value of a target duty cycle for the non-coherent transmission, based on an allowable maximum transmission power for the non-coherent transmission, wherein signaling the UE to perform the non-coherent transmission comprises signaling an indication of the value of the target duty cycle to the UE.

Aspect 17: A method for wireless communication by a user equipment (UE), comprising: determining at least one signal strength parameter associated with a network entity at the UE, wherein a value of the at least one signal strength parameter is less than a threshold associated with a target bandwidth; transmitting an indication of the at least one signal strength parameter to the network entity; after transmitting the indication of the at least one signal strength parameter, receiving a message from the network entity triggering the UE to perform a non-coherent transmission; and after receiving the message, transmitting the non-coherent transmission to the network entity.

Aspect 18: The method of Aspect 17, wherein the at least one signal strength parameter comprises at least one of a signal-to-noise ratio (SNR) or a signal-to-interference-plus-noise ratio (SINR).

Aspect 19: The method according to any of Aspects 17-18, wherein transmitting the indication of the at least one signal strength parameter comprises transmitting channel state information (CSI) associated with a set of channel state information reference signal (CSI-RS) resources configured for the UE, wherein the CSI comprises the at least one signal strength parameter.

Aspect 20: The method according to any of Aspects 17-19, wherein: the message comprises an indication of at least one of (i) the target bandwidth, (ii) a target duty cycle for the non-coherent transmission at the target bandwidth or (iii) a target maximum transmission power for the non-coherent transmission at the target bandwidth; and transmitting the non-coherent transmission is further based on at least one of (i) the target bandwidth, (ii) the target duty cycle or (iii) the target maximum transmission power.

Aspect 21: The method according to any of Aspects 17-20, wherein: the message comprises an indication of a slot aggregation parameter to be used for the non-coherent transmission; and transmitting the non-coherent transmission is further based on the slot aggregation parameter.

Aspect 22: The method according to any of Aspects 17-21, further comprising: receiving an indication of a modified target bandwidth, wherein the modified target bandwidth is associated with a value of the at least one signal strength parameter being greater than a threshold; and transmitting another non-coherent transmission at the modified target bandwidth.

Aspect 23: The method according to any of Aspects 17-22, further comprising: receiving an indication of a value of a target duty cycle for the non-coherent transmission, wherein the value of the target duty cycle is based on at least one of the target bandwidth or a subcarrier spacing associated with the non-coherent transmission; and transmitting the non-coherent transmission according to the value of the target duty cycle.

Aspect 24: The method of Aspect 23, further comprising: transmitting feedback comprising at least one of (i) one or more power measurements, (ii) an indication of decoding performance of messages from the network entity, or (iii) a result of one or more cyclic redundancy checks (CRCs); receiving an indication of an updated value of the target duty cycle; and transmitting another non-coherent transmission according to the updated value of the target duty cycle.

Aspect 25: The method according to any of Aspects 23-24, further comprising receiving an indication of at least one of: (i) a value of the target bandwidth from a plurality of predefined values of the target bandwidth or (ii) a value of the subcarrier spacing from a plurality of predefined values of the subcarrier spacing, wherein the other non-coherent transmission is transmitted according to at least one of the value of the target bandwidth or the value of the subcarrier spacing.

Aspect 26: The method according to any of Aspects 17-22, further comprising: receiving an indication of a value of a target duty cycle for the non-coherent transmission, wherein the value of the target duty cycle is based on an allowable maximum transmission power for the non-coherent transmission; and transmitting the non-coherent transmission according to the value of the target duty cycle.

Aspect 27: An apparatus for wireless communication, comprising: one or more memories collectively storing executable instructions; and one or more processors coupled to the one or more memories, the one or more processors being collectively configured to execute the executable instructions to cause the apparatus to perform a method in accordance with any of Aspects 1-16:

Aspect 28: An apparatus, comprising means for performing a method in accordance with any of Aspects 1-16.

Aspect 29: A non-transitory computer-readable medium comprising computer-executable instructions that, when executed by one or more processors of a processing system, cause the processing system to perform a method in accordance with any of Aspects 1-16.

Aspect 30: A computer program product embodied on a computer-readable storage medium comprising code for performing a method in accordance with any of Aspects 1-16.

Aspect 31: An apparatus for wireless communication, comprising: one or more memories collectively storing executable instructions; and one or more processors coupled to the one or more memories, the one or more processors being collectively configured to execute the executable instructions to cause the apparatus to perform a method in accordance with any of Aspects 17-26.

Aspect 32: An apparatus, comprising means for performing a method in accordance with any of Aspects 17-26.

Aspect 33: A non-transitory computer-readable medium comprising computer-executable instructions that, when executed by one or more processors of a processing system, cause the processing system to perform a method in accordance with any of Aspects 17-26.

Aspect 34: A computer program product embodied on a computer-readable storage medium comprising code for performing a method in accordance with any of Aspects 17-26.

The techniques described herein may be used for various wireless communication technologies, such as NR (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G), Evolved UTRA (E-UTRA), Ultra Mobile Broadband (UMB), Institute of Electrical and Electronics Engineers (IEEE) 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

The techniques described herein may be used for the wireless networks and radio technologies mentioned above as well as other wireless networks and radio technologies. For clarity, while aspects may be described herein using terminology commonly associated with 3G, 4G, and/or 5G wireless technologies, aspects of the present disclosure can be applied in other generation-based communication systems.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS.

A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (cMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block” (RB)) may be 12 subcarriers (or 180 kHz). Consequently, the nominal Fast Fourier Transfer (FFT) size may be equal to 128, 256, 512, 1024 or 2048 for system bandwidth of 1.25, 2.5, 5, 10, or 20 megahertz (MH2), respectively. The system bandwidth may also be partitioned into subbands. For example, a subband may cover 1.8 MHZ (e.g., 6 RBs), and there may be 1, 2, 4, 8, or 16 subbands for system bandwidth of 1.25, 2.5, 5, 10 or 20 MHz, respectively. In LTE, the basic transmission time interval (TTI) or packet duration is the 1 ms subframe.

NR may utilize OFDM with a CP on the uplink and downlink and include support for half-duplex operation using TDD. In NR, a subframe is still 1 ms, but the basic TTI is referred to as a slot. A subframe contains a variable number of slots (e.g., 1, 2, 4, 8, 16, . . . slots) depending on the subcarrier spacing. The NR RB is 12 consecutive frequency subcarriers. NR may support a base subcarrier spacing of 15 KHz and other subcarrier spacing may be defined with respect to the base subcarrier spacing, for example, 30 kHz, 60 kHz, 120 kHz, 240 kHz, etc. The symbol and slot lengths scale with the subcarrier spacing. The CP length also depends on the subcarrier spacing. Beamforming may be supported and beam direction may be dynamically configured. MIMO transmissions with precoding may also be supported. In some examples, MIMO configurations in the DL may support up to 8 transmit antennas with multi-layer DL transmissions up to 8 streams and up to 2 streams per UE. In some examples, multi-layer transmissions with up to 2 streams per UE may be supported. Aggregation of multiple cells may be supported with up to 8 serving cells.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

In some examples, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering. For example, processors 258, 264 and 266, and/or controller/processor 280 of the UE 120a and/or processors 220, 230, 238, and/or controller/processor 240 of the BS 110a shown in FIG. 2 may be configured to perform one or more operations in call flow diagram 500 of FIG. 5, operations 900 of FIG. 9, and/or operations 1000 of FIG. 10.

Means for receiving or means for obtaining may include a transceiver, a receiver or at least one antenna and at least one receive processor illustrated in FIG. 2. Means for transmitting, means for sending, means for signaling, means for indicating, or means for outputting may include, a transceiver, a transmitter or at least one antenna and at least one transmit processor illustrated in FIG. 2. Means for including, means for modifying, means for selecting, means for updating, means for indicating, means for performing, means for detecting, means for providing, means for determining, means for monitoring, and means for initiating may include a processing system, which may include one or more processors, such as processors 258, 264 and 266, and/or controller/processor 280 of the UE 120a and/or processors 220, 230, 238, and/or controller/processor 240 of the BS 110a shown in FIG. 2.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a UE 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein and illustrated in FIG. 5, FIG. 9 and/or FIG. 10.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. An apparatus for wireless communication, comprising:
one or more memories collectively storing computer-executable instructions; and
one or more processors communicatively coupled to the one or more memories, the one or more processors being collectively configured to execute the computer-executable instructions to cause the apparatus to:
obtain an indication of at least one signal strength parameter associated with the apparatus at a user equipment (UE);
signal the UE to perform a non-coherent transmission when a value of the at least one signal strength parameter is less than a threshold associated with a target bandwidth; and
monitor for the non-coherent transmission from the UE.

2. The apparatus of claim 1, wherein the at least one signal strength parameter comprises at least one of a signal-to-noise ratio (SNR) or a signal-to-interference-plus-noise ratio (SINR).

3. The apparatus of claim 1, wherein to obtain the indication of the at least one signal strength parameter, the one or more processors are further configured to cause the apparatus to receive channel state information (CSI) associated with a set of channel state information reference signal (CSI-RS) resources configured for the UE, wherein the CSI comprises the at least one signal strength parameter.

4. The apparatus of claim 1, wherein the one or more processors are further configured to cause the apparatus to:
detect at least one of (i) a radio frequency (RF) link failure between the apparatus and the UE or (ii) one or more cyclic redundancy check (CRC) failures associated with one or more messages transmitted to the UE; and
responsive to the detection, determine that the value of the at least one signal strength parameter is less than the threshold.

5. The apparatus of claim 1, wherein the one or more processors are further configured to cause the apparatus to obtain an indication of one or more parameters associated with a communication channel between the apparatus and the UE, wherein signaling the UE to perform the non-coherent transmission occurs after a determination that the one or more parameters satisfy one or more second conditions.

6. The apparatus of claim 5, wherein the one or more parameters comprise at least one of a delay spread, a maximum Doppler spread, received power, transmission bandwidth, or a subcarrier spacing.

7. The apparatus of claim 5, wherein the one or more second conditions comprise at least one of (i) a target duty cycle for the non-coherent transmission at the target bandwidth or (ii) a target maximum transmission power for the non-coherent transmission at the target bandwidth.

8. The apparatus of claim 7, wherein the target duty cycle is less than or equal to 1.

9. The apparatus of claim 7, wherein the target maximum transmission power for the non-coherent transmission is greater than an average transmission power used for a transmission with a longer duration than the non-coherent transmission.

10. The apparatus of claim 7, wherein to signal the UE to perform the non-coherent transmission, the one or more processors are further configured to cause the apparatus to signal an indication of at least one of the target bandwidth, the target duty cycle for the non-coherent transmission at the target bandwidth, or the target maximum transmission power for the non-coherent transmission at the target bandwidth.

11. The apparatus of claim 10, wherein to signal the UE to perform the non-coherent transmission, the one or more processors are further configured to cause the apparatus to signal an indication of a slot aggregation parameter to be used for the non-coherent transmission.

12. The apparatus of claim 1, wherein the one or more processors are further configured to cause the apparatus to:
modify the target bandwidth until the value of the at least one signal strength parameter is greater than the threshold; and
signal the UE to perform the coherent transmission at the modified target bandwidth.

13. The apparatus of claim 1, wherein the one or more processors are further configured to cause the apparatus to:
select a value of a target duty cycle for the non-coherent transmission, from a plurality of predefined values of the target duty cycle, based on at least one of the target bandwidth or a subcarrier spacing associated with the non-coherent transmission, wherein in order to signal the UE to perform the non-coherent transmission, the one or more processors are further configured to cause the apparatus to signal an indication of the value of the target duty cycle to the UE.

14. The apparatus of claim 13, wherein the one or more processors are further configured to cause the apparatus to:
receive feedback from the UE;
update the value of the target duty cycle after receiving the feedback, wherein the feedback comprises at least one of (i) one or more power measurements, (ii) an indication of decoding performance of messages from the apparatus, or (iii) a result of one or more cyclic redundancy checks (CRCs); and
signal an indication of the updated value of the target duty cycle to the UE.

15. The apparatus of claim 14, wherein the one or more processors are further configured to cause the apparatus to:
select at least one of (i) a value of the target bandwidth from a plurality of predefined values of the target bandwidth or (ii) a value of the subcarrier spacing from a plurality of predefined values of the subcarrier spacing.

16. The apparatus of claim 1, wherein the one or more processors are further configured to cause the apparatus to:
select a value of a target duty cycle for the non-coherent transmission, based on an allowable maximum transmission power for the non-coherent transmission, wherein in order to signal the UE to perform the non-coherent transmission, the one or more processors are further configured to cause the apparatus to signal an indication of the value of the target duty cycle to the UE.

17. An apparatus for wireless communication, comprising:
one or more memories collectively storing computer-executable instructions; and
one or more processors communicatively coupled to the one or more memories, the one or more processors being collectively configured to execute the computer-executable instructions to cause the apparatus to:
determine at least one signal strength parameter associated with a network entity at the apparatus, wherein a value of the at least one signal strength parameter is less than a threshold associated with a target bandwidth;
transmit an indication of the at least one signal strength parameter to the network entity;
after transmission of the indication of the at least one signal strength parameter, receive a message from the network entity triggering the apparatus to perform a non-coherent transmission; and
after reception of the message, transmit the non-coherent transmission to the network entity.

18. The apparatus of claim 17, wherein the at least one signal strength parameter comprises at least one of a signal-to-noise ratio (SNR) or a signal-to-interference-plus-noise ratio (SINR).

19. The apparatus of claim 17, wherein in order to transmit the indication of the at least one signal strength parameter, the one or more processors are further configured to cause the apparatus to transmit channel state information (CSI) associated with a set of channel state information reference signal (CSI-RS) resources configured for the apparatus, wherein the CSI comprises the at least one signal strength parameter.

20. The apparatus of claim 17, wherein the message comprises an indication of at least one of (i) the target bandwidth, (ii) a target duty cycle for the non-coherent transmission at the target bandwidth or (iii) a target maximum transmission power for the non-coherent transmission at the target bandwidth; and transmission of the non-coherent transmission is further based on at least one of (i) the target bandwidth, (ii) the target duty cycle or (iii) the target maximum transmission power.

21. The apparatus of claim 17, wherein the message comprises an indication of a slot aggregation parameter to be used for the non-coherent transmission; and transmission of the non-coherent transmission is further based on the slot aggregation parameter.

22. The apparatus of claim 17, wherein the one or more processors are further configured to cause the apparatus to:
receive an indication of a modified target bandwidth, wherein the modified target bandwidth is associated with a value of the at least one signal strength parameter being greater than a threshold; and
transmit another non-coherent transmission at the modified target bandwidth.

23. The apparatus of claim 17, wherein the one or more processors are further configured to cause the apparatus to:
receive an indication of a value of a target duty cycle for the non-coherent transmission, wherein the value of the target duty cycle is based on at least one of the target bandwidth or a subcarrier spacing associated with the non-coherent transmission; and
transmit the non-coherent transmission according to the value of the target duty cycle.

24. The apparatus of claim 23, wherein the one or more processors are further configured to cause the apparatus to:
transmit feedback comprising at least one of (i) one or more power measurements, (ii) an indication of decoding performance of messages from the network entity, or (iii) a result of one or more cyclic redundancy checks (CRCs);
receive an indication of an updated value of the target duty cycle; and
transmit another non-coherent transmission according to the updated value of the target duty cycle.

25. The apparatus of claim 24, wherein the one or more processors are further configured to cause the apparatus to:
receive an indication of at least one of: (i) a value of the target bandwidth from a plurality of predefined values of the target bandwidth or (ii) a value of the subcarrier spacing from a plurality of predefined values of the subcarrier spacing, wherein the other non-coherent transmission is transmitted according to at least one of the value of the target bandwidth or the value of the subcarrier spacing.

26. The apparatus of claim 17, wherein the one or more processors are further configured to cause the apparatus to:
receive an indication of a value of a target duty cycle for the non-coherent transmission, wherein the value of the target duty cycle is based on an allowable maximum transmission power for the non-coherent transmission; and
transmit the non-coherent transmission according to the value of the target duty cycle.

27. A method for wireless communication by a network entity, comprising:
obtaining an indication of at least one signal strength parameter associated with the network entity at a user equipment (UE);
signaling the UE to perform a non-coherent transmission when a value of the at least one signal strength parameter is less than a threshold associated with a target bandwidth; and
monitoring for the non-coherent transmission from the UE.

28. A method for wireless communication by a user equipment (UE), comprising:
determining at least one signal strength parameter associated with a network entity at the UE, wherein a value of the at least one signal strength parameter is less than a threshold associated with a target bandwidth;
transmitting an indication of the at least one signal strength parameter to the network entity;
after transmitting the indication of the at least one signal strength parameter, receiving a message from the network entity triggering the UE to perform a non-coherent transmission; and
after receiving the message, transmitting the non-coherent transmission to the network entity.
